(19) United States
(12) Patent Application Publication
(10) Pub. No.: US 2004/0218752 A1
(43) Pub. Date: Nov. 4, 2004

(54) Conference speakerphone

(76) Inventors: Wesley Huang, Hsin-Chu (TW); Tom Chen, Hsin-Chu (TW); Clark C. M. Huang, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/428,090

(22) Filed: May 2, 2003

(51) Int. Cl. H04M 3/42; H04M 1/00

(52) U.S. Cl. 379/387.01; 379/207.02

(57) ABSTRACT

A conference speakerphone comprises a conference telephone host and a plurality of separate microphones. A DSP, a control unit, a telephone interface and a microphone interface are disposed in the conference telephone host. The telephone interface is used to achieve signal connection with a telecommunications network. The control unit is responsible for control of interface and logic action. The DSP is used to cancel echo signals of communication and detect the loss of echo signals. The DSP will send an indication signal to the control unit once detecting abnormal echoes. The control unit will then send out a control command to the microphone via the microphone interface for adjusting the microphone according to the control command. Thereby, automatic detection of abnormal echoes and maintenance of communication quality can be accomplished, and the cost can also be lowered.

### FIELD OF THE INVENTION

The present invention relates to a conference speakerphone and, more particularly, to a conference speakerphone having mechanisms for detection of echo return loss and independent selection of microphone.

### BACKGROUND OF THE INVENTION

Along with continual progress of science and technology, when a telephone user wants to communicate together with two or more other users, he uses a long-haul conference speakerphone to convene a conference. Users at different locations can thus attend the conference via the telecommunications network, hence meeting the requirement of high efficiency for modern people. Usually, the users only need a telephone and a pre-registered telephone conference number and a password to connect together via the conference speakerphone. Loudspeaker equipments can be provided so that users attending the conference can hear the speech of another user at any other location.

A digital signal processor (DSP) is usually disposed in a conventional conference speakerphone. The DSP comprises an acoustic echo cancellation (AEC) module and a line echo cancellation (LEC) module. Digital echo cancellation techniques are exploited to let the conference speakerphone accomplish full-duplex communication (simultaneous reception and transmission) quality. Because of limit of length variation of the telephone line, if the communication is made at a distance far away from the telephone office, the voice will attenuate 2 dB per kilometer. In order to keep a more stable sound volume, an automatic gain control (AGC) module is usually added to change the gain according to signal level for keeping stable sound volume and quality. However, the cost is much increased.

Besides, the above conference speakerphone has no echo return loss (ERL) detection mechanism, and the selection mechanism between the microphone and the conference speakerphone host is not independent. Therefore, the conference speakerphone may be easily affected by the environment, and abnormal echoes between the microphone and loud speaker cannot be avoided. For instance, normal operation will be affected if a paper covers the loud speaker or microphone. Additionally, a highly sensitive microphone easily has the problem of noise.

Accordingly, the present invention aims to propose a conference speakerphone to solve the problems in the prior art.

### SUMMARY OF THE INVENTION

The primary object of the present invention is to provide a conference speakerphone, wherein an echo return loss (ERL) module of the host detects abnormal echoes between the microphone and the telephone line to let the microphone flash its indication lamp, thereby reminding the user to adjust the position and direction of the microphone and thus solving the problem of abnormal echoes and susceptibility to the environment in the prior art.

Another object of the present invention is to provide a conference speakerphone, wherein the conference speakerphone host and the microphones are separated to enhance insulation between them and select the microphones independently. The capability of an acoustic echo cancellation (AEC) module can thus be much enhanced to effectively increase the sound volume and quality of reception.

Yet another object of the present invention is to provide a conference speakerphone, wherein only an ERL module and an independent selection mechanism of microphone are exploited to maintain the sound volume and quality, hence lowering the cost.

Still yet another object of the present invention is to provide a conference speakerphone, wherein voice signals are transmitted between the conference telephone host and the microphones in wireless way to accomplish convenient use.

According to the present invention, a conference speakerphone comprises a speakerphone host with a DSP disposed therein and a plurality of microphones. The DSP is connected to a telephone interface and a control unit. The control unit is connected to the telephone interface and a microphone interface. The telephone interface is used to achieve signal connection with a telecommunications network. The control unit is responsible for control of interface and logic action. The DSP is used to cancel echo signals of communication via the telephone line and detect the loss of echo signals. The DSP will send an indication signal to the control unit once detecting abnormal echoes. The control unit will then send out a control command. The microphones achieve signal connection with the microphone interface. An indication lamp will flash according to the control command sent out by the conference telephone host to remind the user to adjust the microphone.

The various objects and advantages of the present invention will be more readily understood from the following detailed description when read in conjunction with the appended drawings, in which:

### BRIEF DESCRIPTION OF THE DRAWINGS

FIG. 1 is an architecture diagram of the present invention;

FIG. 2 is a structure block diagram of the present invention;

FIG. 3 is a detailed circuit diagram of the present invention;

FIG. 4 is a diagram showing wired transmission of signals between the conference speakerphone host and the microphone of the present invention; and

FIG. 5 is a diagram showing wireless transmission of signals between the conference telephone host and the microphone of the present invention.

### DETAILED DESCRIPTION OF THE PREFERRED EMBODIMENTS

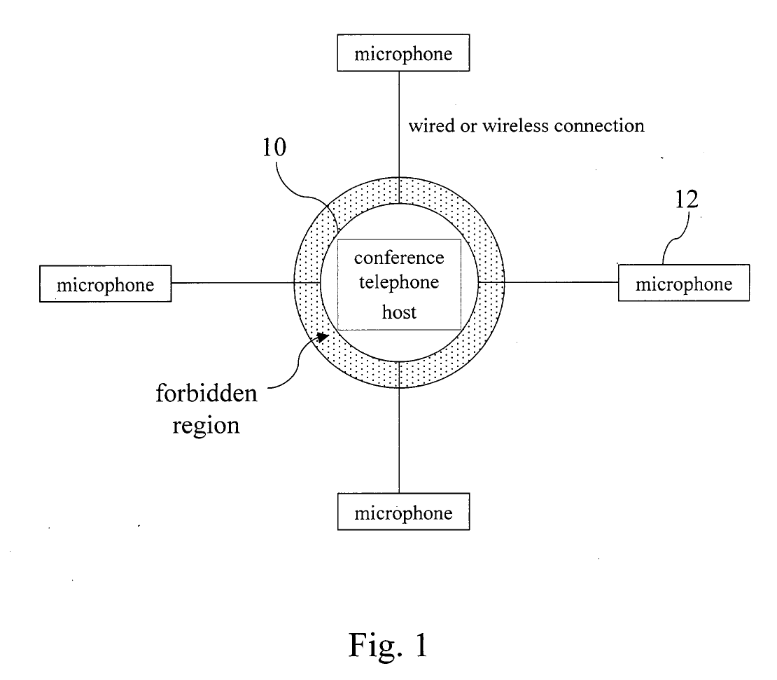

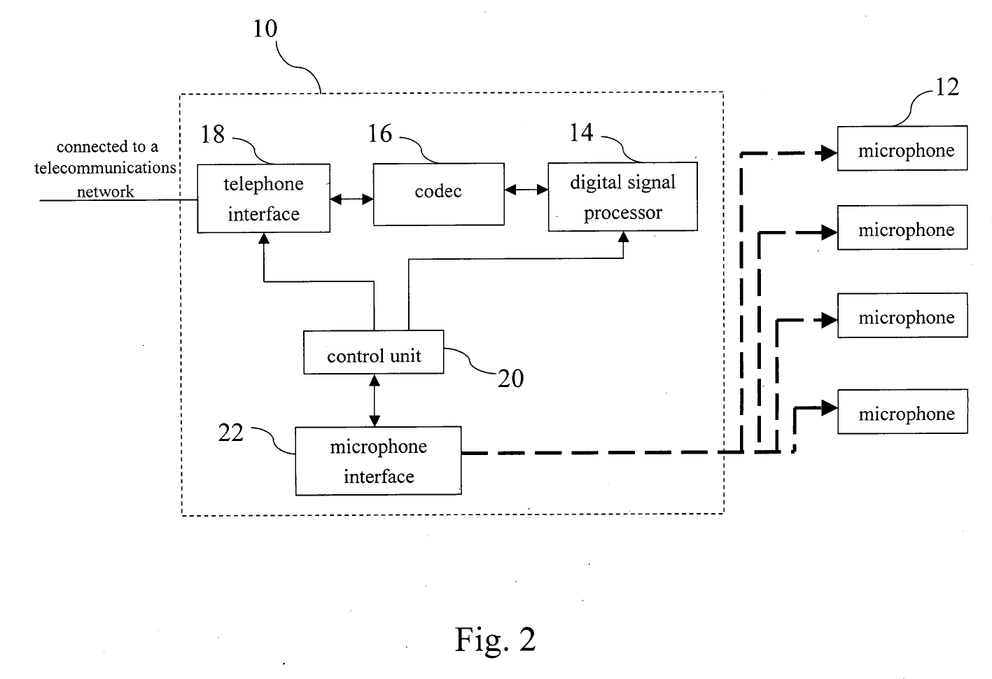

As shown in FIG. 1, a conference speakerphone comprises a conference speakerphone host 10 and four separate microphones 12. Signal connection is accomplished between the conference speakerphone host 10 and the microphone 12 in wired or wireless way. As shown in FIG. 2, a digital signal processor (DSP) 14 is disposed in the conference speakerphone host 10. The DSP 14 is first connected to a codec 16 and then to a telephone interface 18. A control unit 20 is also provided and connected to the DSP 14, the telephone interface 18 and a microphone interface 22. The telephone interface 18 is used to achieve signal connection with a telecommunications network. The control unit 20 is usually a microprocessor, and is responsible for control of interface and logic action. The microphone interface 22 is a time division multiplex (TDM) interface, and is used to process and discriminate signal handshaking and transmission between the conference telephone host 10 and the microphones 12. The codec 16 is responsible for conversion of analog signal and digital signal of voice between the telephone interface 18 and the DSP 14.

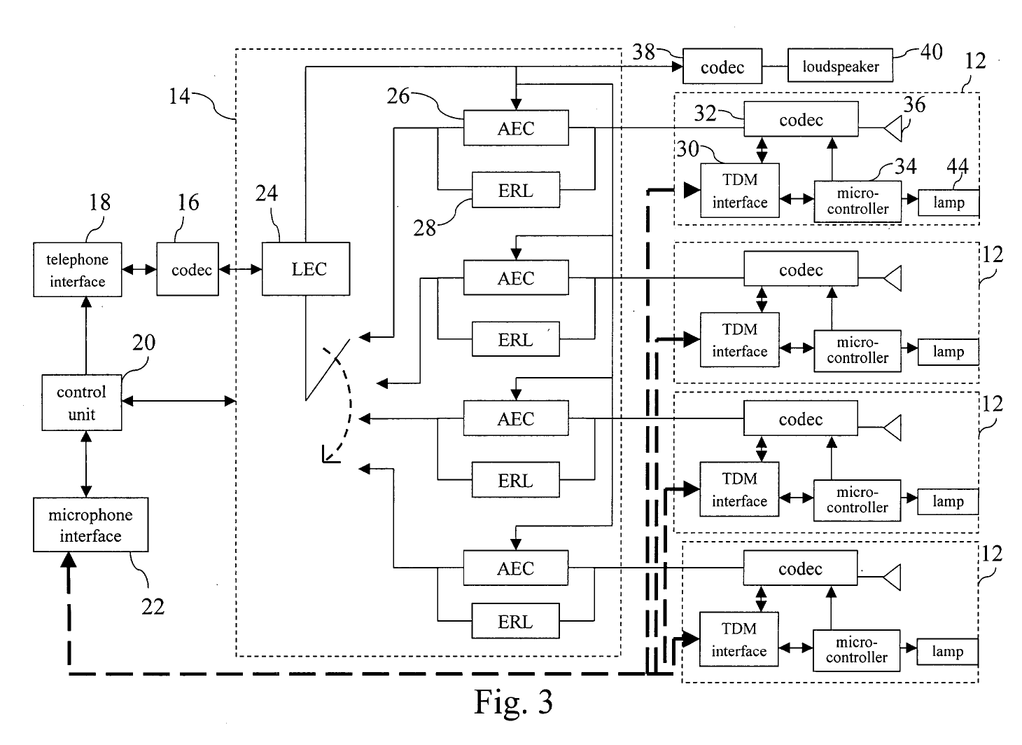

As shown in FIG. 3, the DSP 14 comprises a line echo cancellation (LEC) module 24, four acoustic echo cancellation (AEC) modules 26 corresponding to the microphones 20, and four echo return loss (ERL) modules 28 for detecting signal difference between input and output of each of the AEC modules 26. The AEC modules 26 are used to cancel reception echoes, i.e., echoes formed by sound given out by a speaker and reflected by air or walls and then received by the microphones 12. The LEC module 24 is used to cancel transmission echoes, i.e., echoes formed by sound entering the microphones 12 and transmitted to the telephone line and then rebounded back. The LEC module 24 and the AEC modules 26 are used to cancel echo signals of communication through the telephone line, and the ERL modules 28 are used to detect the loss of echo signals to decrease the echo gain of the voice signal path of the whole system to be smaller than 1, hence accomplishing full-duplex communication quality (simultaneous transmission and reception). Additionally, the DSP 14 is connected to a codec 38 for converting digital signals into analog signals. The codec 38 is connected to a loudspeaker 40 (usually a horn) to amplify and play sound.

The microphones units 12 achieve signal connection with the conference telephone host 10. Each of the microphones units 12 comprises a TDM interface 30, a codec 32, a micro-controller 34, a microphone 36 and an LED indication lamp 44. The TDM module 30 is used to accomplish digital signal connection with the microphones units interface 22 of the conference telephone host 10. Two ends of the codec 32 are respectively connected to one of the AEC modules 26 and the microphone 36 to convert the analog signals inputted by the microphone signals (analog signals) into digital signals and then transmit to the AEC module 26. The micro-controller 34 is connected to the TDM interface 30, the codec 32 and the LED indication lamp 44, and is used to receive a control command from the control unit 20 of the conference telephone host 10 via the TDM module 30 for generating an action signal. The LED indication lamp 44 will flash according to the action signal to remind the user to adjust the position and direction of the microphone 12.

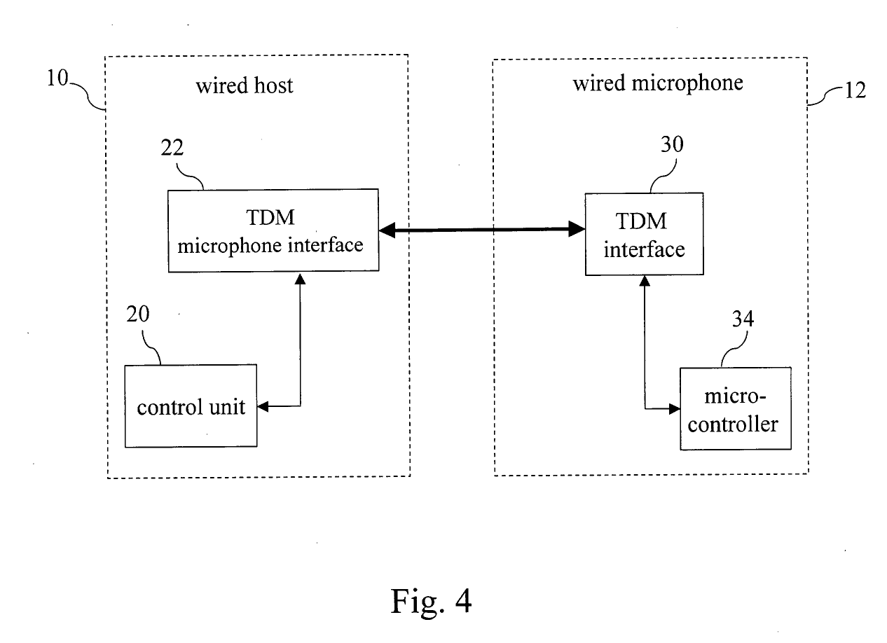

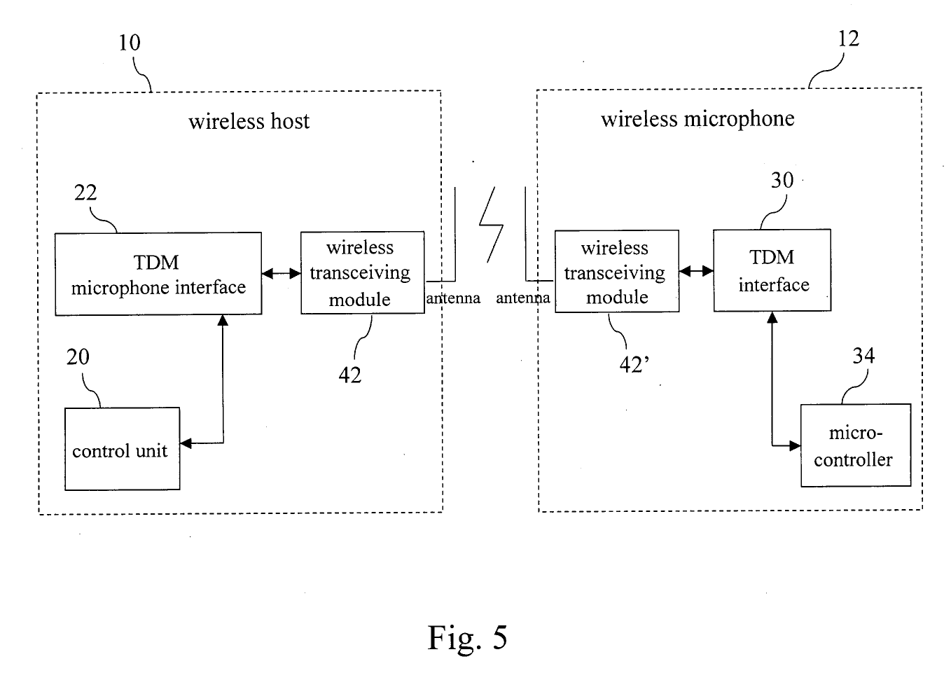

FIG. 4 is a diagram showing wired transmission of signals between the conference telephone host 10 and the microphone 12 of the present invention, wherein the microphone interface 22 and the TDM interface 30 are connected through a line. On the other hand, FIG. 5 is a diagram showing wireless transmission of signals between the conference telephone host and the microphone of the present invention. The microphone interface 22 in the conference speakerphone host 10 is connected with a wireless transceiving module 42, and the TDM interface 30 in the microphone 12 is also connected with a wireless transceiving module 42′. The frequency hopping technique is exploited to transmit digitized voice signals in the legal 2.4 GHz band from the wireless microphone 12 to the conference speakerphone host 10 to accomplish signal connection.

The working principle of the conference unit system is described below. The conference speakerphone system makes use of communication signals (e.g., dial tone or ring back tone) existent on a telephone line to determine whether the echo is too large. Please refer to FIGS. 1 and 3 again. When the position of the microphone 12 is moved to the restricted region to generate abnormal echoes, the ERL module 28 detects the loss of the abnormal echoes and then sends an indication signal to the control unit 20. The control unit 20 sends out a control command to the micro-controller 34 of the microphone 12 via the microphone interface 22. The micro-controller 34 generates an action signal according to the control command and sends to the LED indication lamp 44 connected therewith. The LED indication lamp 44 will flash according to the action signal to remind the user to adjust the position and direction of the microphone 12 to shift the microphone away from the forbidden region of the conference telephone host 10, hence letting the whole system be in optimum working state. The conference speakerphone system can thus accomplish optimum full duplex performance through this action.

To sum up, the present invention makes use of the ERL module to automatically detect abnormal echoes between the microphone and telephone line so as to remind the user to adjust the position and direction of the microphone, thereby keeping good communication quality. Moreover, an independent selection mechanism of microphone is used to maintain sound volume and quality and also lower the cost. Besides, wireless transmission technique is used between the conference telephone host and the microphones to accomplish more convenient use.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A conference speakerphone system comprising:
a conference telephone host with a DSP disposed therein, said DSP being connected to a telephone interface and a control unit, said control unit being connected to said telephone interface and a microphone interface, said telephone interface being used to achieve signal connection with a telecommunications network, said control unit being responsible for control of interface and logic action, said DSP being used to cancel echo signals of communication via the telephone line and detect the loss of echo signals, said DSP sending an indication signal to said control unit once detecting abnormal echoes to let said control unit send out a control command; and
a plurality of microphones each achieving signal connection with said microphone interface, aid microphones being adjusted according to said control command sent out by said conference speakerphone host.

2. The conference speakerphone as claimed in claim 1, wherein said DSP comprises a line echo cancellation module, a plurality of acoustic echo cancellation modules corresponding to said microphones, and a plurality of echo return loss modules, said echo return loss modules are used to detect signal difference at two ends of said acoustic echo cancellation modules, said acoustic echo cancellation modules are used to cancel reception echoes, and said line echo cancellation module is used to cancel transmission echoes.

3. The conference speakerphone as claimed in claim 1, wherein a codec is further connected between said telephone interface and said DSP.

4. The conference speakerphone as claimed in claim 1, wherein said microphone interface is a time division multiplex interface, and is used to process and discriminate signal handshaking and transmission with said microphones.

5. The conference speakerphone as claimed in claim 1, wherein a wireless transceiving module is respectively connected with said microphone interface and each of said microphones to achieve signal connection.

6. The conference speakerphone as claimed in claim 1, wherein signal connection is accomplished between said microphone interface and said microphones in wired way.

7. The conference speakerphone as claimed in claim 1, wherein a loudspeaker is further connected with said DSP.

8. The conference speakerphone as claimed in claim 1, wherein each of said microphones further comprises:
a time division multiplex interface for providing digital signal connection with said conference telephone host;
a codec connected to one of said acoustic echo cancellation modules and responsible for converting analog signals of voice into digital signals; and
a micro-controller connected to said time division multiplex interface and said codec to receive said control command from said conference speakerphone host for generating an action signal.

9. The conference speakerphone as claimed in claim 8, wherein said microphone is further connected with an indication lamp, which is connected to said micro-controller and will flash according to said action signal to remind the user to adjust the position and direction of said microphone.

10. The conference speakerphone as claimed in claim 1, wherein said conference telephone host is separated from said microphones.
